(19) United States
(12) Patent Application Publication
(10) Pub. No.: US 2005/0267786 A1
(43) Pub. Date: Dec. 1, 2005

(54) Travel assistance program

(76) Inventor: Mary Patricia Lang, Boynton Beach, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/140,117

(22) Filed: May 27, 2005

Related U.S. Application Data
(60) Provisional application No. 60/575,116, filed on May 27, 2004.

(51) Int. Cl. G06F 17/60

(52) U.S. Cl. 705/5

(57) ABSTRACT

The subject invention provides a unique and advantageous system for providing travel companion services, thereby effectively filling customer service need for travelers. In another aspect the subject invention provides an effective business model that is beneficial to travelers, travel companion providers, and the travel industry.

### CROSS-REFERENCE TO A RELATED APPLICATION

This application claims the benefit of U.S. Provisional Application Ser. No. 60/575,116, filed May 27, 2004, which is hereby incorporated by reference in its entirety.

### FIELD OF THE INVENTION

The subject invention provides a unique and advantageous travel assistance program. More specifically, the subject invention provides systems and methods wherein a travel companion assists elderly, minors and, in general, any individual who is in need of personal assistance and guidance when traveling.

### BACKGROUND OF THE INVENTION

While more people are now traveling across the U.S. and between different countries than ever before, there still are many individuals who find traveling difficult and inaccessible to them. These people tend to underutilize transportation services to their detriment and to the detriment of the transportation industry.

There are many reasons why people may be hesitant to travel. Even prior to heightened concerns regarding airline security and safety, the complicated and sometimes physically-challenging nature of traveling created a considerable obstacle that discouraged many people from traveling. Airports, for example, have become larger and more complex making it extremely difficult for the elderly, young children, first time travelers or others with physical challenges, to find their way and make plane connections. The process of carrying heavy luggage, checking in, and gathering luggage after a flight can also be very daunting.

This problem is exacerbated by, for example, the increased utilization by many airlines of automated “check-in” processes, where the passengers are now frequently requested to check-in with computerized machines to receive their boarding passes. Many individuals, and, particularly the elderly and first-time fliers, can be intimidated by such computerized processes.

The increased security screening of all passengers as the result of heightened security alerts in the U.S. and elsewhere also discourages many individuals from traveling as do language barriers for non-English speaking people traveling in the U.S., and English speaking people traveling in other parts of the world.

Also, young minors are expected to have an adult companion when traveling by airplane (and other transportation systems), making it inconvenient, if not prohibitive, for certain minors to utilize these transportation systems.

In order to exist in the highly competitive airline industry, major airlines have been forced to retreat from offering many gratuitous customer services. All of these circumstances, and others, function as factors that discourage some groups of the general public from traveling.

Therefore, there is a need for improving the ability of many people to travel, particularly by air. Airlines cannot afford to cater to individual passengers with special needs. What is needed is a means to meet the specific needs of these individuals who are discouraged from utilizing travel services due to the various challenges that travel poses. The subject invention addresses these issues.

### BRIEF SUMMARY OF THE INVENTION

The subject invention provides a unique and advantageous system for providing travel companion services, thereby effectively filling an important void that has previously existed in customer service for travelers. In another aspect the subject invention provides an effective business model that is beneficial to travelers, travel companion providers, and the travel industry.

In accordance with one embodiment of the subject invention, a traveler is provided with a companion who assists the traveler in addressing and overcoming the myriad of challenges and obstacles facing the traveler. The exact nature and significance of travel obstacles can vary between different individuals and their mode of transportation and, therefore, the system of the subject invention, in a preferred embodiment, provides individual travelers with companions who possess specific skills that are most relevant to that individual traveler.

Specifically exemplified herein is a method for facilitating safe, efficient, and pleasant air travel for individuals who would otherwise not be inclined to travel by air. These individuals might be, for example, the elderly, first time flyers, minors, individuals with ailments, and those with a fear of flying.

In a specific embodiment, the methods of the subject invention provide a new standard of professional air travel assistance to passengers with individual based needs and wants. When practiced as described herein, the subject invention provides a high level of service, safety, convenience and comfort for passengers.

In addition to, and as part of, the system for travel companions, the subject invention provides a unique business model that makes it economically and logistically possible to implement the advantageous travel companion service described herein. This business plan envisions the use of alliances with travel providers, such as air carriers, in ways which benefit the particular providers, the industry as a whole and, of course, the individual traveler.

In one embodiment, the subject invention utilizes electronic and information technologies to establish and maintain quality control throughout the system. By very selective hiring of travel companion professionals, this combination of technology, quality oversight, and service orientation keeps costs at a minimum and maximizes efficiency and profitability of the system.

The system of the subject invention helps build strong customer satisfaction and an excellent reputation for the airlines (or other travel organizations) that participate. This, in the long run, promotes travel and increases both revenue and jobs for people associated with the transportation industry.

In addition, while providing appropriate and long-needed services to these potential travelers, the subject invention also provides a way for the travel industry to increase both passenger revenue and create more jobs within the industry.

### BRIEF SUMMARY OF THE FIGURES

FIG. 1 illustrates a flow diagram of a specific embodiment of a method for providing travel companion services.

### DETAILED DESCRIPTION

The subject invention provides a unique and advantageous system for providing travel companion services. This system and accompanying business model provide an important service whereby the comfort and safety of travelers can be significantly enhanced.

In accordance with the subject invention, a traveler is provided with a companion who assists the traveler in confronting the myriad of challenges and obstacles facing the traveler. The exact nature and burden of various obstacles depend on many factors including for example, the method of transportation and the specific limitations that a person may have. Therefore, the system of the subject invention, in a preferred embodiment, provides individual travelers with companions who possess specific skills that are most relevant to that individual traveler.

Specifically exemplified herein is a method for facilitating safe, efficient, and pleasant air travel for individuals who would otherwise be disinclined to travel by air. These individuals might be, for example, the elderly, very young, people with ailments, and those with a fear of flying.

The subject invention further provides, for the first time, a unique business model that makes it economically and logistically possible to implement the advantageous travel companion services described herein. This business plan envisions the use of alliances with travel providers, such as air carriers in ways which benefit the particular providers, the industry as a whole and, of course, the individual traveler.

The system of the subject invention helps build strong customer satisfaction and an excellent reputation for the airlines (or other organizations) that participate. This, in the long run, promotes travel and increases both revenue and jobs for people associated with the transportation industry.

Travel Companion Services

In a preferred embodiment, the system of the subject invention provides travelers with a companion who is knowledgeable with regard to traveling and capable of assisting a traveler in reaching his or her destination safely and conveniently. Thus, the travel companion is carefully selected and/or trained to assist with the type of travel contemplated by the traveler.

In an embodiment specifically exemplified herein the mode of travel is by air. In this context the companion would be able to provide services specifically adapted for air travel and, in a preferred embodiment, the services are particularly well adapted for the individual who will be traveling with the companion.

Other modes of transportation to which the methods and services of the subject invention can be applied include, but are not limited to, trains, buses, and boats.

Also, specifically exemplified herein is the provision of travel companion services for the elderly. As used herein, “elderly” would typically refer to somebody over 60 years old, and the service is particularly well adapted for those over 70 years old and especially those over 75 years old. In one embodiment, a child of the traveler arranges for the travel assistance as described herein. Preferably, the child makes the arrangements at least in part by visiting a web site on the internet.

Other individuals who can benefit from the services provided according to the subject invention include young minors, particularly children under 10 years old and even children under 5 years old. The services are also very useful for those with a fear of flying or even apprehension concerning the logistics of making it though airports to reach flights, make connections, and/or locate checked bags or secure ground transportation.

In one embodiment on the subject invention, the services provided include making all, or part, of the travel arrangements as well as accompanying the traveler during the trip. These services address previously unmet needs of travelers.

In the case of air travel, the services that might be provided by the companion include, but are not limited to, being capable of carrying luggage and/or arranging for transportation of luggage; knowledge of check-in procedures (including international procedures, when appropriate); translation of ticketing and boarding instructions and any general information; knowledge of airport layouts, including intra-airport transportation systems, to facilitate retrieval of luggage and making flight connections; knowledge of airline carry-on luggage rules and boarding procedures; able to assist passenger with locating seat and storing luggage; able to make alternative travel and/or lodging arrangements in the event of unexpected delays or other changes in travel plans; able to reassure and calm an apprehensive traveler; able to facilitate de-planing and retrieval of stowed and checked luggage; coordination of wheelchair and/or golf cart transport from gate to gate or gate to baggage claim; knowledge of procedures for locating lost luggage; knowledge of procedures for reporting damaged luggage; able to secure appropriate ground transportation and deliver the passenger safely and efficiently to ground transportation; and knowledge of internal airport communication and security systems so that travelers can find people who have come to meet with them and/or address security issues as they arrive.

As noted above, the methods of the subject invention are particularly well adapted for providing air travel companion services to elderly population, minors and, in general, any group having special needs, for example, people with disabilities (preferably not ambulatory); first time flyers; people afraid to fly due to high security alert warnings, language barriers, or other reasons; aiding family emergencies; and assisting passengers with serious but non-contagious illnesses. For example, all travel companions can be bonded and certified in CPR, First Aid and First Responder techniques.

Furthermore, specially trained travel companions can be made available. In one embodiment, medically trained personnel, for example, registered nurses, licensed practical nurses, and nurse's aides, can assist injured or ailing patients. Other travel companions undergo further specialized training in traveling with and assisting the blind, deaf, obese and severely geriatric, pediatric and psychologically unbalanced individuals.

In one embodiment of the subject invention, travel companions are recruited from trained available personnel who have been laid off. Preferably, flight attendants who have been laid off due to reduction in the carrier work force, are working reduced hours or choose to leave an airline are hired as travel companions. Advantageously, former flight attendants are trained professionals who understand the operations of the aviation industry. In yet another embodiment, travel companions are recruited from personnel who only work seasonally within their trained professions, for example, teachers. Additional training enhances the overall level of services when traveling as a travel companion.

Advantageously, all travel can be coordinated through already established U.S. airline transportation system (or other transportation systems). The travel companion service company negotiates with the individual airlines for the cost of each roundtrip airfare purchased through the company. In one embodiment, each airline ticket price is fixed and is available for purchase at any time up to 24 hours before travel. In yet another embodiment, the travel companion service company negotiates the price of each roundtrip airfare at the time of purchase.

The method of the subject invention can further comprise a packaged cost for travel by the passenger. In one embodiment, the travel companion service organization packages two roundtrip airfare tickets (one for the passenger and one for the companion) and the cost for services. In yet another embodiment, the purchaser requests a travel companion for the return flight for an additional fee.

Methods of the subject invention also provide options for the passenger or the passenger's representative to purchase the travel companion service and airline tickets. In one embodiment, the purchaser utilizes an Internet website where the desired tickets are reserved and securely purchased using techniques known in the internet consumer arts. The web site further queries the purchaser concerning the needs and issues of each passenger.

In yet another embodiment, the purchaser contacts the travel companion service organization directly via telephone. Preferably, a toll free number is available to facilitate customer service. The organization professional who coordinates with the telephone purchaser also conducts a query about the concerns and issues of the passenger.

In yet another embodiment, the purchaser works with a travel agent who can then coordinate with the travel companion service organization.

In a preferred embodiment, when the passenger is confirmed for travel, the confirmed reservation internally goes to the travel companion service company for scheduling. Scheduling comprises setting up all line travel including air travel routing, seat assignment, and assignment of the appropriate travel companion for each passenger request based on passenger profile wants and needs. A confirmation of the travel plans is transmitted to the passenger.

On the eve of travel, the assigned travel companion may contact the passenger and confirms of the travel arrangements and plans.

On the day of travel, the travel companion can meet the passenger curbside or at another predetermined location and assist the passenger in checking in at the ticket counter or in the automated computer kiosk, security, boarding, in-flight service, deplaning, changing planes (if necessary), gathering luggage from the baggage terminal and delivering the client at their final destination. In the event of flight cancellations, overbookings, and/or delays the travel companion makes all necessary arrangements through the air service travel companion and/or airline personnel to insure that the passenger arrives at the final destination.

In one embodiment, the travel companion returns to his or her home base after the passenger arrives at the appropriate destination. In another embodiment, the travel companion meets another passenger and accompanies him or her on their travels.

Advantageously, all travel activities can be electronically tracked during points of travel. The purchaser of the services can provide the names and contact information of individuals whom they wish to be updated with travel information during the course of the flight(s).

Another aspect of the methods of the subject invention is directed to supplying travel companions for other modes of transportation including, without limitation, boats, trains, buses, or providing trained drivers. In one embodiment, the travel companion service provides a companion who assists the passenger on all cruise ship activities and is booked in a cabin adjacent to the passenger's cabin.

In the case of cruising, the services that might be provided by the companion include, but are not limited to, being capable of carrying luggage and/or arranging for transportation of luggage; knowledge of check-in procedures (including international procedures, when appropriate); translation of instructions and pertinent information; knowledge of port layouts, including intra-port transportation systems, to facilitate retrieval of luggage; able to assist passenger with locating the appropriate cabin, dining hall, activities center, deck, etc.; able to make alternative travel and/or lodging arrangements in the event of unexpected delays or other changes in travel plans; and able to reassure and calm an apprehensive traveler.

In the case of train travel, the companion is preferably booked into the sleeping cabin adjacent to the passenger and is able to assist the passenger in boarding and disembarking the train, traveling to the dining car, correctly disembarking at the correct stop, carrying luggage, holding the tickets, checking in and claiming luggage.

In another embodiment, the travel companion service company provides a professionally trained driver to transport the passenger from one location to another. The automobile may belong to the passenger, may be rented by the passenger or the travel companion service company or be owned by the company. In another embodiment, the professional driver may be responsible for transporting the purchaser's automobile from one location to another. For example, many persons live in the southern U.S. during the winter months but reside at their primary residence for the interim of the year. A professional driver provided by the travel companion service company can drive the person's car from their primary residence to the winter residence while the owner flies to the destination.

Business Model

In a further embodiment, the subject invention provides a unique business system that is beneficial to the consumer (travelers), the investors in the companion service business, the companions and other people employed by the service, and the transportation industry.

In a specific embodiment, the business system of the present invention is based on the concept of air travel companion services. Advantageously, the business model of the subject invention provides a growth opportunity in the travel sector. Thus, a preferred embodiment of the subject invention is directed to the aviation industry. The business systems of the subject invention are particularly advantageous and timely in view of the constant growing economic pressures within the air travel transportation industry, in the U.S. and abroad. Understanding the vital need to increase, or at least maintain, existing passenger load traffic is critical to the survival of air carriers competing in an already very aggressive market.

The subject invention envisions the creation of new air travel companion service company in the U.S., and eventually in Europe and elsewhere. The mission of this company is directed towards providing traveling companion services, wherein travel occurs through the already established airline transportation system. The business system of the subject invention increases passenger revenue and provides more jobs in an already economically starved job market. Most additional services provided by an individual carrier are not paid for in the price of a consumer air travel ticket, and therefore are gratuitous by the carrier. When utilizing the methods of the subject invention, air carriers are relieved of certain customer service demands that can be very time consuming and costly. High risk liabilities are also decreased.

The business model also facilitates and contemplates providing exclusive customer services to individual passengers with individual based needs and desires, and is designed, in a preferred embodiment to ensure the highest level of service, safety, convenience and comfort to every passenger that utilizes the system. In a preferred environment, an organizational and marketing strategy can be implemented that will, beginning its first year of service operation, provide special services to at least 10 percent of the total U.S. airline market industry.

In addition, the business model is further directed to gear operations and present professional, serious growth oriented image from the onset that will set the stage for reasoned, planned expansion that will enable this service to expand in scope from an initial regional status to continental and intercontinental services.

Objectives to be pursued in accordance with the business model of the subject invention include identifying and developing key interline alliances with highly regarded airlines both within and beyond an initial target region that will support the travel service through, for example, discounted or special rates, frequent flyer mileage sharing, special seat assignments, and other passenger and client advantages created through interline arrangements, code shares, and so forth.

In one specific embodiment, the subject invention contemplates the sale of two revenue seats on a carrier for every one travel companion request.

In a preferred embodiment the business model can include the following objectives:

1. Establish and provide an air travel companion service. The intent is for the service to ultimately be available to the entire U.S. air travel public and services will be rendered throughout the entire U.S. air transportation system. Preferably, the service establishes travel companions from eastern U.S. urban cities, for example, Boston, New York, Newark, Washington, D.C., Atlanta, Orlando, Tampa, Miami, Ft. Lauderdale, and West Palm Beach. All travel can be coordinated through the established U.S. major airline transportation system.

2. Provide services to address unmet demands in key air passenger traffic categories thereby resulting in an increase in travel by the elderly population, minors, and in general, those with special needs (i.e. people with disabilities, first time flyers, people afraid to fly, (including those with fears concerning security alert warnings). The services can also include aiding in family emergencies, assisting passengers with serious but non contagious illnesses, etc. In addition, an effort can be made to serve key niche markets where demand is either unmet or poorly serviced due to certain regional, seasonal, and or variable routes where predictably high passenger loads exist and prevent current carriers from adequately providing such services.

3. Provide exclusive customer service to individual passengers with individual based needs and wants, and ensure the highest level of service, safety, convenience and comfort to every customer.

4. Create a professional, serious, growth-oriented image from the onset, which will set the stage for reasoned, planned expansion, mirroring growth rates projected for the first year of operations and will enable this service to extend regional scope and, in future years, to transition from its initial regional status to continental and intercontinental services.

5. Other key objectives include: to identify and develop key interline alliances, cooperations, and associations, with highly regarded airlines both within and beyond the initial target region that support this travel service through discounted or special fares, frequent flyer mileage sharing, seat assignments, and other passenger and client advantages created through interline arrangements, code shares, and so forth.

Additional important features of the subject invention can include, for example, the following:
Employing an experienced, highly professional management team that combines vision; realism; financial ability; solid knowledge of the aviation business; familiarity with and belief in, the utilization of the latest electronic and informational technologies; on-the-ground knowledge of the region and markets to be served; realization of the crucial importance of an organization's personnel to its success; and total familiarity with, and commitment to, the overall mission and goals of the proposed new travel service.
Intelligent, progressive, and aggressive marketing that identifies this travel service as a different kind of player, one that is sharper and smarter and with a higher level of professionalism and operational standard than is the norm in the targeted region(s).
Concentration on safety with highly trained, dedicated and professional personnel, caring for the passenger and the passengers needs and wants. The advantages offered by this type of special service will be straightforward, understandable, and will include fair and reasonable pricing which all will form key pillars of the marketing strategy.
Identification, through careful market research, of served, unserved or underserved routes in target market areas where passenger demand is high and identifies the need for higher special passenger needs. Providing additional service in these markets will produce profitable operations and increase both name and special service recognition.
Identifying, negotiating, and entering into, in the pre-operational stage and early on, beneficial associations, cooperations, and partnerships with large established highly regarded domestic and or international carriers both within and beyond the target market regions to offer interline arrangements through special fares, possible frequent-flyer mileage sharing, convenient hubbing and long distance connections to both special service passenger and travel companion passengers. Successful execution of this element of the business plan is crucial to the overall success and growth of this service, and must be kept in mind in the organizational plan and structuring of this service company.
Establishing a high level of operational oversight and quality control that will insure this service will live up to its marketing commitments and fulfill the promise of high level customer service, satisfaction, convenience, and safety, at a reasonable fare.
Use of electronic and informational technology to reduce over staffing and other operational costs; expand the potential market base; readily capture sales opportunities; simplify and speed the process of passenger airport check-in, security screening, travel and deliver all passengers to their final destination and enhance all customer travel experience, convenience and satisfaction.
Maintaining flexibility that enables this service to always respond and adapt to changing market conditions and opportunities, without being erratic, and by employing staffing on a basis that is better then sufficient to get the job done properly, efficiently, and at a high rate of return.
Avoiding growth for growths sake, and instead look for solid niche-enlargement opportunities that will allow incremental, but always profitable expansion by constantly identifying and developing cost effective opportunities for new markets, new market concepts and expand sales potential.

All patents, patent applications, provisional applications, and publications referred to or cited herein are incorporated by reference in their entirety, including all figures and tables, to the extent they are not inconsistent with the explicit teachings of this specification. It should be understood that the examples and embodiments described herein are for illustrative purposes only and that various modifications or changes in light thereof will be suggested to persons skilled in the art and are to be included within the spirit and purview of this application.

### EXAMPLE 1

### Method of Providing Travel Companion Services to an Airline Passenger

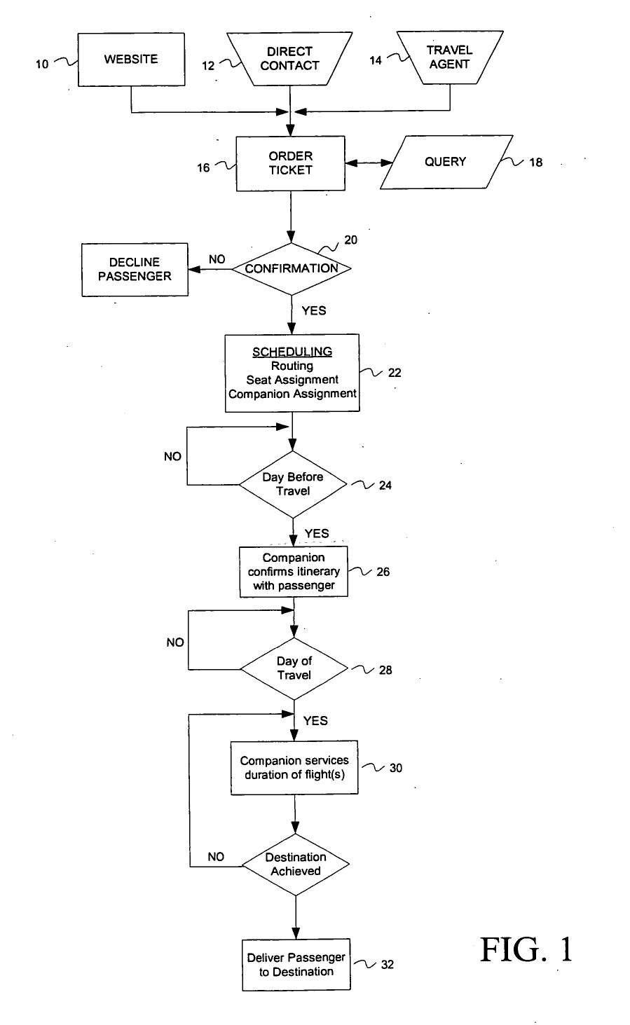

Referring to FIG. 1, the prospective passenger or his or her representative contacts the travel companion services organization among three possible routes—via the Internet, directly contacting the company, or through the services of a travel agent. The passenger orders a ticket to the destination of his or her choice and is queried regarding any necessary issues or needs.

The travel companion services organization either confirms or declines to confirm the passenger for travel. If the passenger is confirmed for travel, the travel services company routes the passenger on the appropriate flight, assigns a seat and assigns a travel companion.

On the day before travel, the assigned travel companion confirms the itinerary with the passenger. On the day of travel, the travel companion provides the necessary services to escort the passenger during travel until the final destination is reached.

### EXAMPLE 2

### Types of Assistance that can be Provided

The travel assistance provided according to the subject invention can be of, for example, the following types:
Pre-Flight: Reservations (by phone and or website). This service assists individuals in the completion of a passenger profile and purchase of roundtrip airline tickets for travel.
In Flight: On day of travel, a personal flight attendant assists a passenger with individual needs from curbside to their final destination.
In Flight: Web and phone tracking systems provide the location of an individual in route.
After Flight: Follow-up the Customer Care and Quality Assurance Program regarding passenger and staff services.

### EXAMPLE 3

### Specific Details of One Embodiments

The passenger or the passenger's representative can go to a web site to check and/or make a reservation. A passenger profile can be completed in order to purchase a ticket; web sales can be confirmed by a major credit card; a flight itinerary can be printed once a purchase is confirmed.
If web access is unavailable, or if an individual prefers to speak with a real person, a toll free number can be made available.
   Once a Ticket is Purchased
A passenger profile can go to “Scheduling.” Scheduling matches a passenger profile to the most qualified personal flight attendant for travel. Scheduling then confirms all seat assignments and notifies an assigned flight attendant within 48-72 hours of travel by phone and/or e-mail of itinerary as well as providing his/her passenger profile.
   Once a Personal Flight Attendant is Assigned
The personal flight attendant contacts the assigned passenger (or contact person) by phone, preferably the day before travel. The flight attendant introduces themselves, confirms curbside location and time to meet (1.5 hours before departure, for example) and answers any last minute questions and or concerns prior to the day of travel.
In addition, all assigned personal flight attendants should confirm scheduling by e-mail or phone they have contacted and confirmed all final travel arrangements with the assigned passenger.
   Day of Travel
A personal flight attendant should arrive curbside and check-in with Scheduling two hours prior to departure. This allows the flight attendant to be available for early passenger arrivals and or allow extra time to secure any last minute needs (i.e. wheel chairs etc.)
Once the personal flight attendant has met the passenger curbside, together they check-in all luggage, obtain boarding passes, proceed to security, assist and clear security, proceed to the departure gate, board early if necessary, otherwise board immediately after first class/special frequent flyers and comfortably assist and secure the passenger to the assigned seat. Preferably, the personal flight attendant never separates from his/her passenger.
   Before Arriving at a Connecting or Final Destination City
The personal flight attendant confirms gate connections or special needs requests prior to arrival (i.e. wheelchairs). In addition, the personal flight attendant can monitor their tracking system for any last minute changes and or updates from Scheduling regarding connection delays and/or cancellations.
   Once on the Ground at a Connection or Final Destination City
The personal flight attendant assists with the deplaning process, and either proceeds to a connecting flight or delivers the passenger to a contact person as designated from the passenger profile. All passengers are delivered in the airport and, preferably on the other side of the concourse security check point.
In the event a contact person is either late or becomes a no show situation, the personal flight attendant will notify Scheduling. Scheduling will then determine course of action for both the personal flight attendant and passenger.
   Once the Personal Flight Attendant has Delivered the Passenger
The personal flight attendant will proceed to their scheduled flight back to their home base. Preferably, all personal flight attendants will be scheduled to return to their home bases at the end of each travel day.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method for providing travel assistance services for travelers in order to facilitate safe, efficient, and pleasant travel for individuals who otherwise might not be inclined to travel, wherein said method comprises providing a travel companion to the traveler wherein the companion was not previously known to the traveler and wherein the companion is trained to assist the traveler during the traveling process.

2. The method according to claim 1, wherein the mode of transportation for said travel is selected from the group consisting of trains, buses, airplanes, and boats.

3. The method, according to claim 1, wherein the mode of transportation is an airplane.

4. The method according to claim 1, wherein the companion is matched with the traveler so as to provide specific skills that are most relevant to that individual traveler.

5. The method, according to claim 1, wherein the traveler is over the age of 60 and/or has a disability.

6. The method, according to claim 1, wherein the traveler is a child under the age of 10.

7. The method according to claim 1, wherein the services provided include making all, or part, of the travel arrangements as well as accompanying the traveler during the trip.

8. The method according to claim 1, wherein the travel companion is certified in CPR, First Aid and/or First Responder techniques.

9. The method according to claim 1, wherein the services provided include services selected from the group consisting of being capable of carrying luggage and/or arranging for transportation of luggage; knowledge of check-in procedures (including international procedures, when appropriate); translation of ticketing and boarding instructions and any general information; knowledge of airport layouts, including intra-airport transportation systems, to facilitate retrieval of luggage and making flight connections; knowledge of airline carry-on luggage rules and boarding procedures; able to assist passenger with locating seat and storing luggage; able to make alternative travel and/or lodging arrangements in the event of unexpected delays or other changes in travel plans; able to reassure and calm an apprehensive traveler; able to facilitate de-planing and retrieval of stowed and checked luggage; coordination of wheelchair and/or golf cart transport from gate to gate or gate to baggage claim; knowledge of procedures for locating lost luggage; knowledge of procedures for reporting damaged luggage; able to secure appropriate ground transportation and deliver the passenger safely and efficiently to ground transportation; and knowledge of internal airport communication and security systems so that travelers can find people who have come to meet with them and/or address security issues as they arrive.

10. The method according to claim 1, wherein the travel companion is a trained flight attendant.

11. The method according to claim 1, wherein all or part of the arrangements are made on the internet.

12. The method according to claim 1, which comprises making a passenger profile.

13. The method according to claim 1, wherein arrangements for the travel companion are made by a child for the child's parent.

14. The method according to claim 1, wherein the passenger's location and/or activities are electronically tracked.

15. A unique business model wherein the business provides travel assistance services for travelers in order to facilitate safe, efficient, and pleasant travel for individuals who otherwise might not be inclined to travel, wherein said model comprises providing a travel companion to the traveler wherein the companion was not previously known to the traveler and wherein the companion is trained to assist the traveler during the traveling process that makes it economically and logistically possible to implement the advantageous travel companion services.

16. The business model according to claim 15, wherein alliances with travel providers benefit the particular providers, the industry as a whole and the individual traveler.

17. The business model according to claim 15, wherein the mode of transportation for said travel is selected from the group consisting of trains, buses, airplanes, and boats.

18. The business model according to claim 17, wherein the mode of transportation is an airplane.

19. The business model according to claim 15, wherein the model comprises identifying, negotiating, and entering into, in the pre-operational stage and early on, beneficial associations, cooperations, and/or partnerships with established domestic and/or international carriers to offer arrangements through special fares, possible frequent-flyer mileage sharing, convenient hubbing and long distance connections to both special service passenger and travel companion passengers.

20. The business model according to claim 15, wherein discounted tickets are negotiated with a travel provider.
